(19) United States
(12) Patent Application Publication
(10) Pub. No.: US 2023/0334153 A1
(43) Pub. Date: Oct. 19, 2023

(54) DETECT AND PREVENT SYNCHRONIZING OF A CORRUPTED FILE

(71) Applicant: Dell Products, L.P., Round Rock, TX (US)

(72) Inventors: Tomer Shachar, Omer (IL); Yevgeni Gehtman, Modi'in (IL); Maxim Balin, Yavne (IL)

(21) Appl. No.: 17/721,177

(22) Filed: Apr. 14, 2022

(51) Int. Cl. G06F 21/55; H04L 9/40

(52) U.S. Cl. CPC G06F 21/554; H04L 63/10; G06F 2221/034

(57) ABSTRACT

A service monitors activity of a cloud storage during operation of the storage. The service may be a cloud AI service. The AI service may be trained with data labeled as ‘normal’ relative to compressibility of a storage unit of the storage during a known normal period. The service generates storage activity metrics based on the monitored activity and compares the metrics to a normal characteristic activity associated with the cloud storage. The monitored activity may comprise data reduction operations to a storage unit of the cloud storage. If metrics corresponding to monitored activity do not satisfy normal characteristic activity criteria, such as compressibility, the service may determine that the storage has been subjected to a ransomware attack and may initiate an action that protects data of the storage. Corrective actions may be initiated to block access to a suspicious endpoint or revert a storage unit to a previous version.

### BACKGROUND

A computing network that is accessible to a remote (geographically or logically) computing device, or other network, via yet another network such as a communication network, may be referred to as a cloud, or a cloud network. A cloud may facilitate remote storage of files. Furthermore, files may be stored at a cloud data store, such as one or more hard drives, magnetic disk drives, solid state drives, and the like, that may be referred to as a storage. A file stored at the storage may be automatically synchronized with versions of the file that may be stored at one or more remote computing devices when the file is updated from one of the computing devices. However, the capability to share and to synchronize, or ‘sync’, results in opportunities for nefarious actions from hackers and others who seek to create mischief with malware, which may comprise viruses, rootkits, ransomware, and the like. When multiple computing devices are connected to, or in communication with via a network, a cloud data storage, such as a remote server, or a storage device coupled to a remote server, such as a hard drive, a magnetic disk drive, a solid-state drive, and the like, each connected computing device may be susceptible to effects of malware that has infected, or negatively affected, one of the other computing devices. The computing devices, which may be referred to as endpoints, or as corresponding to endpoints—a network address, such as an Internet protocol (IP) address, may correspond to an endpoint, but a device's media access control (MAC) address, for example, or other identifier may be referred to as a unique endpoint identifier—are especially vulnerable to an infection of another device when all of the devices are connected to a cloud storage and are configured to sync files stored on the cloud storage. If a user of one device inadvertently exposes his, or her, computer to a virus, or ransomware, for example, the malware may infect a file on the user's computing device, which infected file may then be synced with a previous version of the file stored at the cloud storage.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Monitoring and detecting, in the cloud, endpoints, or devices corresponding to endpoints that may have been compromised with malicious activity, for example ransomware, may prevent harm to devices that are configured to share and sync files via a cloud storage that the compromised devices use for sharing and syncing.

Cloud infrastructure, by design, may facilitate sharing files in the Cloud with many users that can access the cloud infrastructure. Sync applications, such as Microsoft OneDrive from Microsoft, Inc., may also facilitate the connecting of local directories on a local computing device at an endpoint to a data storage and the sharing and syncing of files stored in the directories with other devices that can access the cloud storage.

When ransomware attacks an endpoint and encrypts one or more files in a folder local to a device at the endpoint (an entire folder or directory may also be encrypted), an encrypted file, files, folder, folders, directory, or directories may automatically sync with a corresponding file, files, folder, folders, directory, or directories stored in a cloud storage and may overwrite an original, or previous, version of the file, files, folder, folders, directory, or directories. Then, other user devices/endpoints typically sync the encrypted version of the encrypted file, files, folder, folders, directory, or directories to corresponding versions of the file, files, folder, folders, directory, or directories stored at their local computing devices.

In an embodiment, a cloud service, which may be referred to as a cloud storage service and may be a service provided by a cloud storage service provider, may monitor metrics generated in the cloud relative to a storage unit, such as a file, folder, directory, or volume stored in a cloud storage. The cloud service may comprise an artificial intelligence (“AI”) algorithm. The cloud service may identify one or more file-sharing locations or user devices/endpoints that may have accessed a storage unit.

The cloud service may monitor activity relative to a storage unit, for example a shared file folder, which activity may comprise data reduction. The cloud service may provide a data reduction status of a storage unit. If the cloud service determines that data reduction of a storage unit exhibits unusual behavior or an unusual characteristic, or is trending toward unusual behavior or an unusual characteristic, the cloud service may cause a mitigation or remediation action to be taken. ‘Normal’ characteristics may be determined as corresponding to data generated during a period, or while a cloud computing activity occurs, that may be labeled as ‘Normal’, with ‘normalness being deemed by information technology personnel, for example, who are associated with operating a cloud storage corresponding to the activity. The data labeled ‘normal’ may be used to train an AI algorithm that may be part of the cloud service. Remediation or mitigation may comprise a cloud service halting activity that may correspond to the determined unusual characteristic, removing cloud access permission for an endpoint that corresponds to the determined unusual characteristic, analyzing the unusual activity to determine if further action may be needed, reverting to a previous version of a file, folder or other storage unit that has not been encrypted by a ransomware attack, or other action to reverse, or reduces the severity of, effects of a ransomware attack.

### BRIEF DESCRIPTION OF THE DRAWINGS

FIG. 1 illustrates a schematic of network cloud synchronizing system.

FIG. 2A illustrates a cloud storage file sharing environment.

FIG. 2A illustrates a cloud storage file sharing environment with shared files maliciously encrypted.

FIG. 3 illustrates a data store with compressible files stored thereon.

FIG. 4A illustrates a data store with compressible files that have been compressed.

FIG. 4B illustrates a data store with maliciously encrypted compressible files that cannot be compressed.

FIG. 5. Illustrates a flow diagram of an embodiment to detect and mitigate a ransomware attack in a cloud environment.

FIG. 6 illustrates a flow diagram of an embodiment to facilitate detection of a ransomware attack in a cloud environment.

FIG. 7 illustrates a computer environment.

FIG. 8 illustrates an exemplary embodiment method to detect and mitigate ransomware in a cloud environment.

FIG. 9 illustrates an exemplary embodiment system to detect and mitigate ransomware in a cloud environment.

FIG. 10 illustrates an exemplary embodiment non-transitory machine-readable medium, comprising executable instructions.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is only illustrative and exemplary of one or more concepts expressed by the various embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

One or more embodiments of the present application minimize firmware or software package updates transmitted to servers remote from a central location from which one or more update packages are distributed.

Usually, a storage unit of a data store, such as a directory, may contain a plurality of files that can be compressed a significant amount. An amount, or percentage, that a storage unit such as a file can be compressed may be referred to as ‘compressibility.’ A premise of deeming compressibility as ‘normal’ is that in an enterprise network environment, enterprise users, such as employees, who store digital files from a local computing device, such as a laptop computer, to a cloud storage, do not typically encrypt the files that they store, or if they encrypt files, it is a very low number of files that the employees encrypt. Thus, when a cloud storage data store performs a routine operation of data reduction, e.g., compressing files in a particular folder to reduce storage space, a success rate associated with the folder in terms of a percentage or files that can be compressed may be very high. It would not be unusual for 99% of an enterprise's file stored in a cloud data store to be reducible, or compressible. (In such a scenario, the 99% may refer to a number of files in a folder that are compressible to some extent, but may refer to a total amount of storage space, e.g., bytes, that can be reduced by compression.) Such a high success rate, or compressibility rate, may be due to the fact that most enterprise files are typically not encrypted. Encrypted files typically cannot be reduced via compression, or at least encrypted files typically cannot be compressed without using a decryption key. Accordingly, if an unusual number, or percentage, of files in a folder cannot be compressed during a routine data reduction operation at a cloud storage, a cloud service may determine that an endpoint that has access to the cloud storage may have been attacked by ransomware that has encrypted data at the endpoint and then the encrypted data has been automatically stored to, or overwritten a previous version of the data at, the cloud storage during a sync operation between the local device/endpoint and the cloud storage.

Data reduction is a parameter corresponding to activity that may be routinely, opr regularly, performed at a cloud storage. A cloud service may calculate one or more metrics corresponding to data reduction activity from monitored cloud storage data reduction activity that may represent how compressible a file is, or how compressible a folder, directory, or volume containing one or more files may be. Compressibility may comprise an amount that a file or other storage unit may be compressed, or reduced in size in terms of bytes, or compressibility may refer to a number of data units within another data unit, for example a number of files within a folder, that can be compressed regardless of an amount in terms of bytes a particular file can be compressed. Compression, which may be hardware-assisted, may be performed in-line as data is received at a cloud storage. Compressibility may be based on how many files can be compressed, or how much data that makes up one or more files of a folder can be compressed. Directories, or volumes, may be already compressed or encrypted, at least partially; data reduction may pertain to an amount of data, or number of files, that can be compressed.

Since a ransomware attack typically encrypts one or more storage units (e.g., files) of an attacked computing device or computing system, and then typically demands compensation in exchange for a decryption key to be used to unencrypt the encrypted storage units, a data reduction parameter metric may be used to determine whether a synced file in a cloud storage may have been corrupted, or at least encrypted, by a ransomware attack. As part of routine in-line data reduction storage operation, a cloud data storage, or a cloud service cooperating therewith, may determine whether a given file that cannot be reduced by data reduction is legitimately compressed or encrypted. Using a determination that a file is already legitimately compressed may reduce the likelihood of a false positive determination that a ransomware attack has occurred.

To determine whether a file has been legitimately compressed, a cloud service may determine a part of the file that may have been reduced in size via data reduction. If the file is legitimately compressed or encrypted, the determination of how much of the file has been compressed should be a high percentage. The cloud service may determine whether a file that has a legitimately high data reduction value, or metric, is a compressed type of file. For example, if a file's file type is MP3, MP4, Zip, RAR, etc., the file likely has an already high data reduction factor, or metric, because the file has been compressed with a legitimate compression algorithm or program. Thus, even if a file already has a high data reduction factor, or metric, associated with it a cloud service may nevertheless determine that ransomware has likely not affected the file.

If a determination is made that a file type of a file does not correspond to a legitimate compression algorithm, then the file is likely encrypted, which could nevertheless be legitimate. For example, if a storage uses end-to-end encryption (only the sending and receiving devices can access encrypted information), or similar, the storage should have available to it a decryption key, and therefore may determine that the file is legitimately encrypted and that the low compressibility, or non-compressibility, associated with file is not due to malicious activity if the file can be decrypted using the decryption key. In an embodiment, a user may disable detection of data reduction for a particular shared and synced storage unit, or may provide a sharing permission for compressed files, such as, for example, .zip files, if the file or other storage unit may result in false positive indications of ransomware.

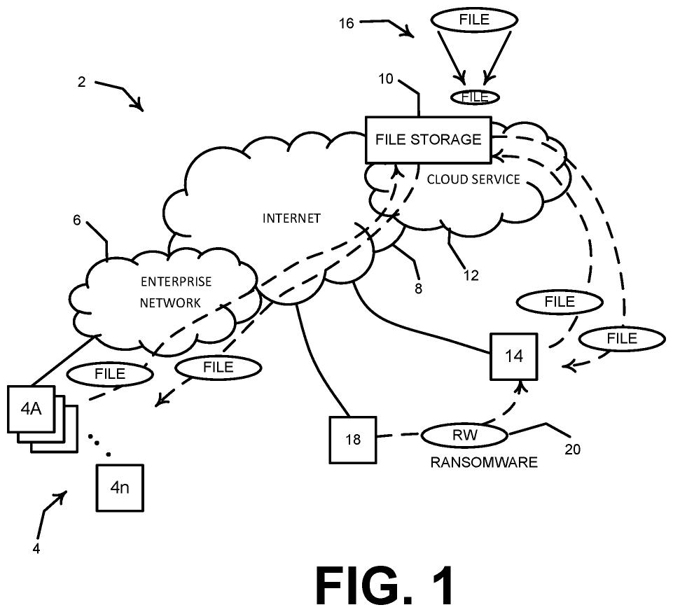

Turning now to FIG. 1, the figure illustrates cloud network environment 2. In environment 2, user device endpoints 4 may be endpoints of an enterprise network 6, or endpoints 4 may represent, or correspond to, enterprise users, such as employees. Endpoints 4 may correspond to users that are not part of an enterprise, but my have access to cloud storage via communication network 8, such at the Internet. Endpoints 4, or devices corresponding thereto, may store files from enterprise network 6 via public communication network 8, with a cloud file storage 10. Cloud file storage 10 maybe part of, operated by, or offered by, cloud service provider's network cloud 12. Network cloud 12 may comprise cloud service 13. Cloud service 13, which may be referred to as a cloud storage service, may comprise an artificial intelligence component, algorithm, service, or other computer resource, that may interact with, interoperate with, coordinate with, cooperate with, or otherwise facilitate file storage, sharing, or synchronizing files stored on file storage 10. Remote endpoint, 14 which may correspond to a user device, such as a laptop computer, a smartphone, a tablet, or similar, may be coupled to public communication network 8 and may obtain, share, or synchronize files that are stored at the remote endpoint, or stored on a computing device corresponding to the remote endpoint, with files that have been shared with, or synced with, computing devices at endpoints 4 via cloud file storage 10.

In an embodiment, as cloud storage 10 receives a file from one of endpoints 4A-4n, or from endpoint 14, a data reduction operation 16 may be performed to reduce an amount of storage space of cloud storage 10 used to store the file in, on, or at the cloud storage. As graphically shown in the figure, data reduction 16 typically attempts to reduce the size of a file stored in cloud storage 10. Data reduction 16 may perform data reduction on storage units, such as files, after the storage unit has been stored to cloud storage 10. In an embodiment, a data reduction operation 16 may be performed on a file inline to, or as the file is being received and stored to, cloud storage 10.

Attack computer 18, which may be coupled with public network 8, may transmit a ransomware message 20, which may comprise a file, a program, a script, data, code, or other form of computer instruction or data, to endpoint 14 via the public network for nefarious purposes. Ransomware message 20 may infect one or more files, or other storage units, stored locally on a device at endpoint 14. A ransomware infection may comprise encrypting a file, or other storage unit, such that a user of a device corresponding to endpoint 14 cannot access the file or other storage unit without a decryption key, for which a user of device 18 typically will demand a ransom. If a file that ransomware 20 infects is a file that is shared, for example, by setting a sharing privilege with respect to the file, between endpoint 14 and cloud storage 10, and furthermore has a file attribute setting that the file should be synchronized with a corresponding file stored at the cloud storage, the file at endpoint 14 that is infected may automatically be transmitted to cloud storage 10 according to a synchronization instruction, for example according to a sync schedule or based on a sync trigger. A sync trigger may comprise a change occurring to the file, which change could be the receiving from end point 14 a file encrypted by ransomware message 20.

In an embodiment, cloud service 13, which may control or manage file reduction operation 16, may determine that a file being received from endpoint 14 may not be compressible. The determination of not being compressible may be based on a comparison to a determined normal characteristic parameter criterion, such as for example, a percentage compressibility of the file. If a file received from endpoint 14 is not compressible (e.g., 0% compressible), a determination may be made that the file is encrypted, or further analysis may be performed to determine whether the non-compressibility status is due to the file-to-be synced/updated at cloud storage 10 being a legitimately compressed file. In this case, a normal data reduction parameter criterion for a file may comprise a compressibility of 95%+/−20%, for example. Since 0% compressibility is less than 95%-20%, the date reduction operation generates a data reduction metric that does not meet the normal data reduction parameter criterion associated with the file and cloud service 13 may instruct the performance of a remediation or mitigation action.

In an embodiment, cloud storage service 13, in management of cloud storage 10, may determine that a storage unit, such as a folder, stored in the cloud storage may not be compressible, or may have a compressibility of less than a normal amount or may not satisfy a criterion. For example, if a folder contains 100 files and on any given routine data reduction operation performed on the folder 98 of the 100 files are compressible, (e.g., the folder is normally 98% compressible in terms of files being at least partially compressible) but for a particular data reduction operation the same folder is not compressible (e.g., 0% compressible) or has a low compressibility (e.g., only 50 files out of 100 are at least partially compressible), the data reduction operation may generate a data reduction metric that does not meet the normal data reduction parameter criterion (e.g., 98%) associated with the folder and cloud service 13 may determine that the folder has been compromised since 0% or 50% compressibility is less than the normal 98%, and the cloud service may instruct the performance of a remediation or mitigation action, such as denial of further syncing and sharing of files stored in the folder or reverting to a previous version, or versions, of files that may have been maliciously encrypted.

In an embodiment, data reduction of a storage unit may occur periodically, and for a particular period covering multiple occurrences of data reduction the storage unit may typically, or normally, have, for example, a compressibility of 95%+/−3% for each data reduction operation within the period. If, during another period covering multiple occurrences of data reduction the compressibility drops to a compressibility outside the range of normal, cloud service 13 may instruct that remediation or mitigation action be taken. For example, if the compressibility of the folder drops to 87%, this is a greater reduction in compressibility of the folder than the normal variance of 3%, within which the lowest the compressibility could drop to would be 92% before the data reduction metric falls below the normal compressibility criterion of 95%+/−3%.

Further mitigation or remediation action may comprise halting activity that corresponds to low, or no, compressibility of a storage unit, removing an endpoint from permission to share or sync files with a cloud storage, or perform analysis. In an embodiment, if cloud storage cloud service 13 determines that a storage unit at cloud storage 10 may have been compromised by a ransomware attack, the cloud storage may revert the storage unit to a previous version of the storage unit that corresponds to a data reduction operation for which a metric was generated that met a normal data reduction criterion for the storage unit. A previous version to which the storage unit reverts may be a version stored at cloud storage 10 or at a device associated with an endpoint that has permission to share and sync files with the cloud storage or with devices associated with other endpoints.

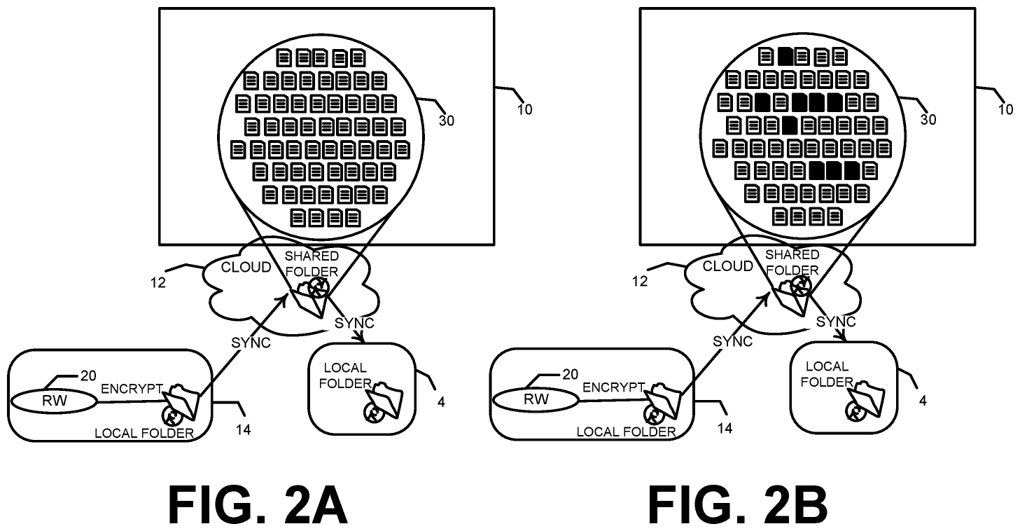

Turning to FIG. 2A, the figure illustrates cloud storage file storing, sharing, and synchronization environment 2 as described above in reference to FIG. 1. In FIG. 2A, a folder 24 is shown comprising sixty files that are stored in cloud storage 10. Files in folder 24 are accessible by computing devices associated with endpoints 4 and 14. When a change is made to a file in a folder local to one of the endpoints, the file is automatically synced via a corresponding file in folder 24 and with a corresponding file in a local folder at the other endpoint. In the figure, files in folder 24 are shown by folder icons with three horizontal lines that represent files that may be compressible. Ransomware message 20 is shown as having been loaded into a computing device at endpoint 14. After ransomware message 20 has loaded at endpoint 14, it begins encrypting files in the local folder that may comprise at least some of the files contained in shared folder 24 at cloud storage 10.

FIG. 2B shows the environment 2 as described in reference to 2A but files encrypted in the local folder at endpoint 14 because of ransomware 20 have begun syncing in shared folder 24 in cloud storage 10. Encrypted files that have been synced to folder 24 are shown as folder icons that are shaded black to represent correspondence to files encrypted by ransomware 20 at local endpoint 14. Cloud service 13 may determine, responsive to performing a data reduction operation on folder 24, that out of 60 files that have been compressible during previous data reduction operations only fifty-one are now compressible and that a data reduction parameter metric does not meet a normal data reduction criterion for shared folder 24 and may restrict files in shared folder 24 from being synced to a folder of endpoint 14 corresponding to the shared folder, among other potential mitigation actions.

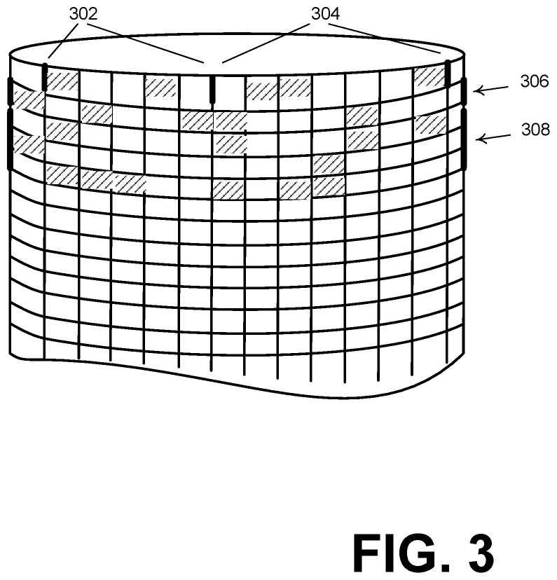

Turning now to FIG. 3, the figure illustrates a volume 30 that contains files 302 and 304 in the first row, file 306 taking up the entire second row, and file 306 taking up rows 3, 4, and 5. Storage blocks that store the files are illustrated bounded by thick black lines. Data that makes up the files are shown as shaded storage blocks and unshaded storage blocks represent storage space unused to store data.

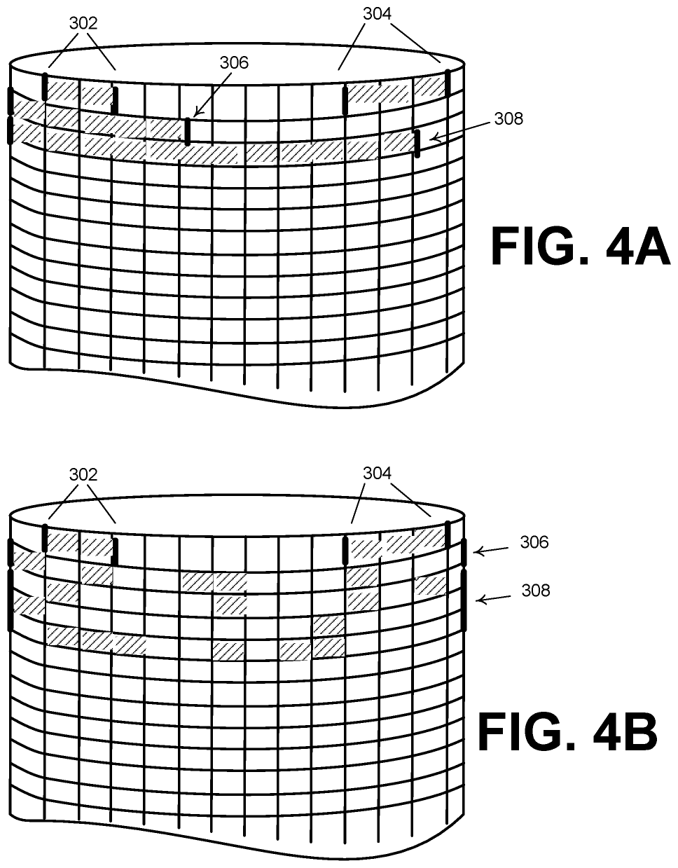

Turning now to FIG. 4A, the figure shows volume 30 after data reduction has been performed on the volume. File 302 has been reduced by compressing data and eliminating unused storage space so that instead of five storage blocks used in FIG. 3 the file only takes up two storage blocks as shown in FIG. 4A. Likewise, file 304 has been compressed via a data reduction operation to take up three storage blocks instead of seven; file 306 has been reduced from consuming fourteen storage blocks as shown in FIG. 3 to consuming only five memory blocks in FIG. 4A; and file 308 has been reduced from consuming forty-two storage blocks as shown in FIG. 3 to consuming only twelve memory blocks in FIG. 4A.

Turning now to FIG. 4B, the figure illustrates a volume 30 after files 306 and 308 have been encrypted due to a ransomware attack. As with the example shown in FIG. 4A, files 302 and 304 have been compressed as shown in FIG. 4B by a data reduction operation performed on volume 30 and consume two storage blocks and three storage blocks, respectively. However, after data reduction has been performed on volume 30, files 306 and 308, which, during a previous data reduction operation were capable of being compressed as described in reference to FIG. 4A, now, as shown in FIG. 4B, cannot be reduced and consume the same amount of storage space in volume 30 as they did as shown in FIG. 3. Since all files in volume 30 were reduceable after a data reduction operation, the results of which are shown in FIG. 4A, compressibility of files 302, 304, 306, and 308 may be deemed a normal data reduction criterion for volume 30. After a data operation determines, as shown in FIG. 4B, that files 306 and 308 are not reduceable, a cloud service such as cloud service 13 shown in FIG. 1 and FIG. 2B, may monitor data reduction of volume 30 and may determine a data reduction metric, or metrics. Such metrics may be a percentage of files that are reduceable, or the amount of storage blocks that are reduceable in results shown in FIG. 4B relative to results shown in FIG. 4A. The compressibility difference between FIG. 4B and FIG. 4A may be 50% vs. 100% of files being reduceable or a percent reduction of storage blocks reduction of 89.7% (61/68) vs. 32.4% (22/68), respectively. If normal data reduction criterion were 98% of files being reduceable or at least 75% of storage blocks consumed by uncompressed files being reduceable (e.g., no longer consumed by the files after file reduction), then a cloud service 13 may determine that a data reduction metric for volume 30 does not meet a normal data reduction criterion, and may cause the implementation of a remediation or mitigation action.

After cloud storage service 13, as shown in FIG. 1, determines that a ransomware attack may have infected, or affected, a storage unit stored at cloud storage 10 that is normally shared and synced with a plurality of endpoint devices 4A-4n or 14, the cloud storage service may lock edit permission for a device corresponding to an endpoint from which the ransomware attack originated, such as endpoint 14 in FIG. 1, and notify the owner of the cloud shared storage (e.g., notify IT personnel of enterprise 2, or IT personnel of an operator of the cloud storage) about the locking of the ransomware origination endpoint. The owner of the cloud shared storage 10 may permit cloud storage service 13 to revert a storage unit, or units, encrypted by the ransomware attack to a previous version of the storage unit(s), thus facilitating devices that correspond to other endpoints that may have already synced with the attacked files to sync again to a safe, previous version of the storage unit, which may be a version of the storage unit(s) (e.g., file(s)) that has/have not changed since a legitimate user last updated the storage unit(s).

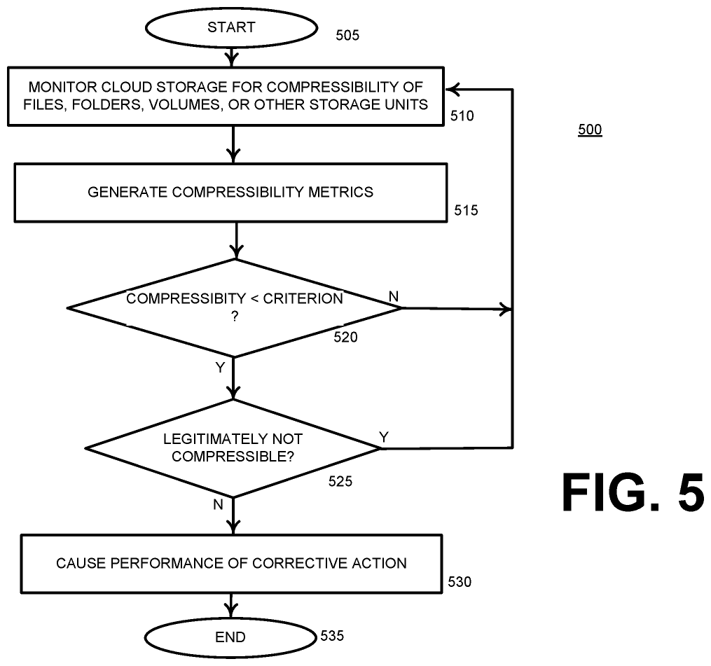

Turning now to FIG. 5, the figure illustrates a flow diagram of an embodiment method 500 to detect and mitigate a ransomware attack in a cloud environment. Method 500 begins at step 505. At step 510 a service running in a cloud computing network that comprises a cloud storage and that is separate from another network, for example an enterprise's computing network, to which a plurality of user computing device may have connectivity at least for purposes of sharing and synchronizing files, monitors activity related to the storage. The service may be an AI service. Examples of activity monitored may comprise data reduction. Results of the activity may be an amount of compressibility of a file, folder, volume, or other storage unit at the storage. The service may generate metrics based on the monitored activity at step 515. Examples of the metrics may comprise a percent compressibility for a given storage unit, a percentage of files that are compressible in a given folder, and the like. The plurality of computing devices may comprise employee laptop computers that connect to the enterprise network and that can access files stored to the storage of the cloud network. As an employee, or other user, reads or writes a file that he, or she, has opened and is using on an employee laptop, the read, write, or other update actions performed to the file may be automatically stored to the root version of the file that is available for sharing from the cloud storage to one or more user computing devices. The root version of a file, or other storage unit, may refer to a version of the storage unit that is physically stored at the cloud storage, and other versions of the storage unit, which may be referred to as remote versions of the same storage unit, may be stored in a memory of one of the user computing devices or may be stored to a storage, such as a disk drive or solid state drive, of one of the user computing devices.

The storage of the cloud computing network, may attempt to perform a data reduction action on one or more storage units of the storage responsive to an instruction periodically, according to a schedule, randomly, or responsive to a manual request from a user, such as an Information Technology personnel. At step 520 the cloud AI service may compare results of a data reduction action of a storage unit to a corresponding normal characteristic criterion corresponding to the data reduction action. For example, a normal characteristic criterion for a storage unit that is a folder may be that 95% of files in the folder are typically compressible to some extent when a data reduction action is performed on the storage unit. If the results of a specific instance of performing a data reduction on the folder is that 90% of the files in the folder are compressible, then a determination may be made as step 520 that the compressibility of 90% of the files is not an uncommon, or abnormal, result, and method 500 returns to step 510. Such a determination may be made based on a predetermined tolerance of 5% relative to the normal number of files that are compressible for the given storage unit.

If, however, for a specific instance of data reduction a result is that only 2% of the files in the folder are compressible, then a determination may be made at step 520 that the results of the data reduction are not common, or are abnormal, because the results are outside of, or less than, the criterion of 95%+/−5%, and method 500 may advance to step 525.

As step 525, a determination may be made whether a high uncompressibility rate (e.g., does not satisfy the criterion) is due to a legitimate reason, such as, for example, one or more files in the folder to which the data reduction action was attempted have been compressed with a data compression application as instructed by a user, or ‘owner’ of the one or more files (e.g., the files have a file type .zip). If a determination is made at step 525 that the result of the attempted data reduction that does not satisfy a normal characteristic criterion is due to a legitimate reason, method 500 returns to step 510 and the cloud service continues to monitor activity of the cloud storage.

If, however, a determination is made at step 525 that a legitimate reason does not explain the failure to satisfy the normal characteristic criterion at step 525, method 500 advances to step 530 and the cloud service may cause one or more mitigation actions. A mitigation action may comprise blocking access by the cloud storage service to the cloud-based storage of one of the remote computing devices that provided a most recent update of a file associated with the characteristic parameter metric that does not satisfy the defined normal characteristic criterion. A remediation action may comprise reverting a file associated with the characteristic parameter metric that does not satisfy the defined normal characteristic criterion to a previous version of the file and synchronizing the previous version to remote computing devices that are communicatively coupled with the cloud-based storage equipment. After causing, or initiating, one or more mitigation actions, method 500 advances to step 535 and ends. A mitigation or remediation action may be broadly referred to as a corrective action. The step of FIG. 5 may be performed by a cloud storage service associated with a cloud storage or by one or more services associated with the cloud storage, including the cloud storage service.

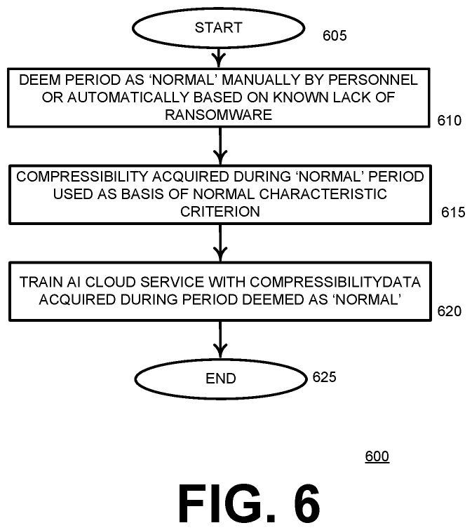

Turning now to FIG. 6, the figure illustrates a flow diagram of an embodiment to facilitate detection of a ransomware attack in a cloud environment. Method 600 begins at step 605. At step 610, personnel, such as, for example, IT personnel of an enterprise, may acquire blocks of data relative to relative to operation of a cloud-based storage. For example, IT personnel may observe performance of a data reduction operation performed during a period that the IT personnel deem as ‘normal.’ The data reduction operation may include attempting to compress a file, a folder, a volume, or attempting to compress other types of storage units. For a given storage unit the IT personnel may deem that a compressibility of a storage unit during the period that the personnel deem as normal may be established as a normal characteristic criterion at step 615. A compressibility may be an amount a storage unit can be compressed in terms of bytes, or other measure of the size of the storage unit. A compressibility may be a number of files contained in a folder that are compressible during a data reduction operation.

At step 620, an AI service corresponding to, and logically, if not geographically, associated with may be trained with data labeled as ‘normal,’ or labeled as corresponding to a normal characteristic criterion, acquired during a ‘normal’ period, or periods. A normal characteristic criterion may comprise a compressibility and a corresponding tolerance, such as a percentage tolerance or a number of files tolerance. As the AI service monitors activity related to the storage, comparison to an AI model trained with the data labeled as normal or labeled as corresponding to a normal characteristic criterion may determine if current, or ‘live’, data observed during operation of the storage may not satisfy the normal characteristic criterion and thus may correspond to a ransomware attack. Method 600 ends at step 625.

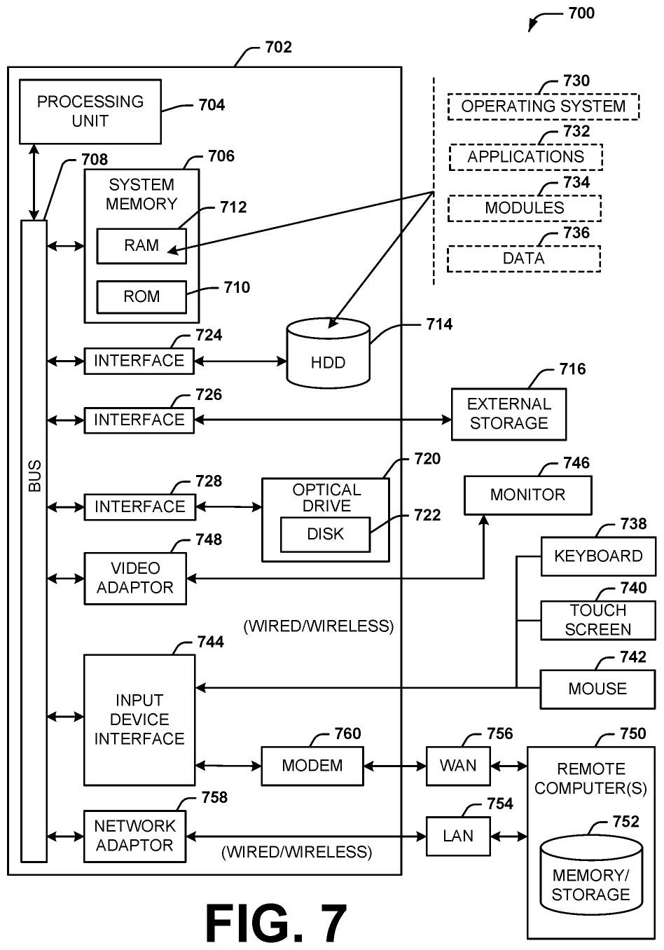

In order to provide additional context for various embodiments described herein, FIG. 7 and the following discussion are intended to provide a brief, general description of a suitable computing environment 700 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 7, the example environment 700 for implementing various embodiments of the aspects described herein includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors and may include a cache memory. Dual microprocessors and other multi-processor architectures can also be employed as the processing unit 704.

The system bus 708 can be any of several types of bus structure that can further interconnect to a memory bus (with or without a memory controller), a peripheral bus, and a local bus using any of a variety of commercially available bus architectures. The system memory 706 includes ROM 710 and RAM 712. A basic input/output system (BIOS) can be stored in a non-volatile memory such as ROM, erasable programmable read only memory (EPROM), EEPROM, which BIOS contains the basic routines that help to transfer information between elements within the computer 702, such as during startup. The RAM 612 can also include a high-speed RAM such as static RAM for caching data.

Computer 702 further includes an internal hard disk drive (HDD) 714 (e.g., EIDE, SATA), one or more external storage devices 716 (e.g., a magnetic floppy disk drive (FDD) 716, a memory stick or flash drive reader, a memory card reader, etc.) and an optical disk drive 720 (e.g., which can read or write from a CD-ROM disc, a DVD, a BD, etc.). While the internal HDD 714 is illustrated as located within the computer 702, the internal HDD 714 can also be configured for external use in a suitable chassis (not shown). Additionally, while not shown in environment 700, a solid-state drive (SSD) could be used in addition to, or in place of, an HDD 714. The HDD 714, external storage device(s) 716 and optical disk drive 720 can be connected to the system bus 708 by an HDD interface 724, an external storage interface 726 and an optical drive interface 728, respectively. The interface 724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 712, including an operating system 730, one or more application programs 732, other program modules 734 and program data 736. All or portions of the operating system, applications, modules, and/or data can also be cached in the RAM 712. The systems and methods described herein can be implemented utilizing various commercially available operating systems or combinations of operating systems.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the .NET framework, for applications 732. Runtime environments are consistent execution environments that allow applications 732 to run on any operating system that includes the runtime environment. Similarly, operating system 730 can support containers, and applications 732 can be in the form of containers, which are lightweight, standalone, executable packages of software that include, e.g., code, runtime, system tools, system libraries and settings for an application.

Further, computer 702 can comprise a security module, such as a trusted processing module (TPM). For instance, with a TPM, boot components hash next in time boot components, and wait for a match of results to secured values, before loading a next boot component. This process can take place at any layer in the code execution stack of computer 602, e.g., applied at the application execution level or at the operating system (OS) kernel level, thereby enabling security at any level of code execution.

A user can enter commands and information into the computer 702 through one or more wired/wireless input devices, e.g., a keyboard 738, a touch screen 740, and a pointing device, such as a mouse 742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 704 through an input device interface 744 that can be coupled to the system bus 708, but can be connected by other interfaces, such as a parallel port, an IEEE 1394 serial port, a game port, a USB port, an IR interface, a BLUETOOTH® interface, etc.

A monitor 746 or other type of display device can be also connected to the system bus 608 via an interface, such as a video adapter 748. In addition to the monitor 746, a computer typically includes other peripheral output devices (not shown), such as speakers, printers, etc.

The computer 702 can operate in a networked environment using logical connections via wired and/or wireless communications to one or more remote computers, such as a remote computer(s) 750. The remote computer(s) 750 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 752 is illustrated. The logical connections depicted include wired/wireless connectivity to a local area network (LAN) 754 and/or larger networks, e.g., a wide area network (WAN) 756. Such LAN and WAN networking environments are commonplace in offices and companies, and facilitate enterprise-wide computer networks, such as intranets, all of which can connect to a global communications network, e.g., the internet.

When used in a LAN networking environment, the computer 702 can be connected to the local network 754 through a wired and/or wireless communication network interface or adapter 758. The adapter 758 can facilitate wired or wireless communication to the LAN 754, which can also include a wireless access point (AP) disposed thereon for communicating with the adapter 758 in a wireless mode.

When used in a WAN networking environment, the computer 702 can include a modem 660 or can be connected to a communications server on the WAN 756 via other means for establishing communications over the WAN 756, such as by way of the internet. The modem 760, which can be internal or external and a wired or wireless device, can be connected to the system bus 708 via the input device interface 744. In a networked environment, program modules depicted relative to the computer 702 or portions thereof, can be stored in the remote memory/storage device 752. It will be appreciated that the network connections shown are example and other means of establishing a communications link between the computers can be used.

When used in either a LAN or WAN networking environment, the computer 702 can access cloud storage systems or other network-based storage systems in addition to, or in place of, external storage devices 716 as described above. Generally, a connection between the computer 702 and a cloud storage system can be established over a LAN 754 or WAN 756 e.g., by the adapter 758 or modem 760, respectively. Upon connecting the computer 702 to an associated cloud storage system, the external storage interface 726 can, with the aid of the adapter 758 and/or modem 760, manage storage provided by the cloud storage system as it would other types of external storage. For instance, the external storage interface 726 can be configured to provide access to cloud storage sources as if those sources were physically connected to the computer 702.

The computer 702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

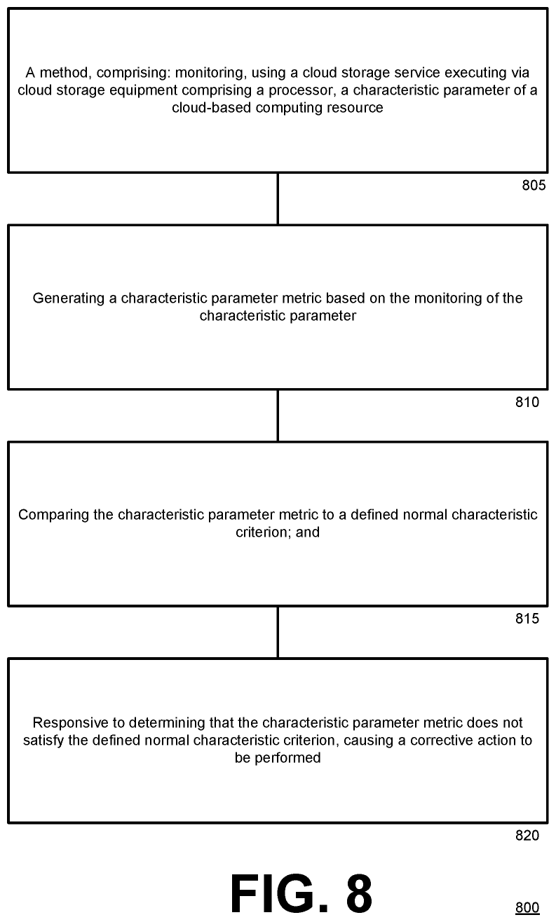

Turning now to FIG. 8, the figure illustrates a block diagram of an embodiment method 800. At block 805 the embodiment method, comprises: monitoring, using a cloud storage service executing via cloud storage equipment comprising a processor, a characteristic parameter of a cloud-based computing resource; at block 810 generating a characteristic parameter metric based on the monitoring of the characteristic parameter; at block 815 comparing the characteristic parameter metric to a defined normal characteristic criterion; and at block 820 responsive to determining that the characteristic parameter metric does not satisfy the defined normal characteristic criterion, causing a corrective action to be performed.

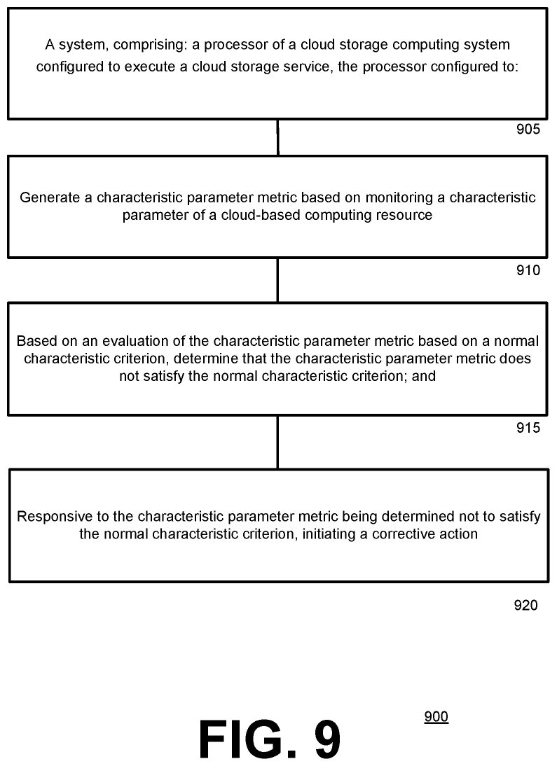

Turning now to FIG. 9, the figure illustrates a block diagram of an embodiment system 900. At block 905 the embodiment system comprises: a processor of a cloud storage computing system configured to execute a cloud storage service, the processor configured to: at block 910 generate a characteristic parameter metric based on monitoring a characteristic parameter of a cloud-based computing resource; at block 915 based on an evaluation of the characteristic parameter metric based on a normal characteristic criterion, determine that the characteristic parameter metric does not satisfy the normal characteristic criterion; and at block 920 responsive to the characteristic parameter metric being determined not to satisfy the normal characteristic criterion, initiating a corrective action.

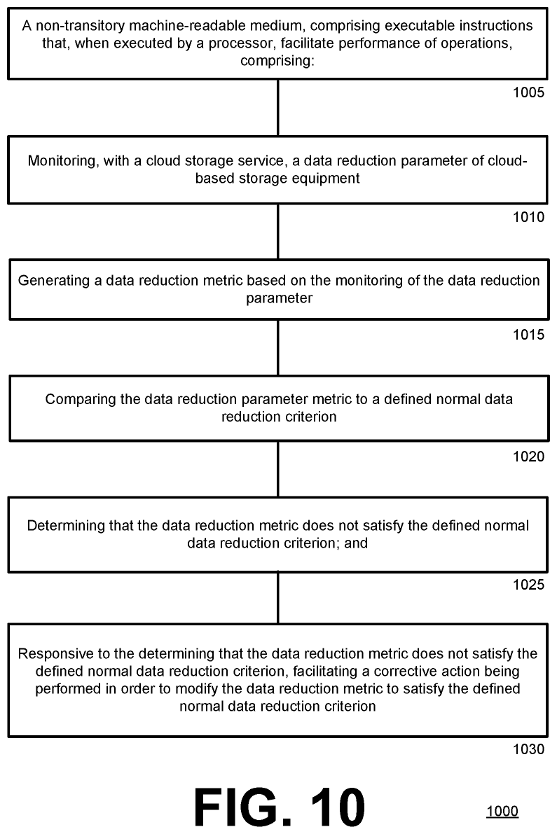

Turning now to FIG. 10, the figure illustrates an embodiment non-transitory machine-readable medium, comprising executable instructions. At block 1005 the non-transitory machine-readable medium, comprises executable instructions that, when executed by a processor, facilitate performance of operations, comprising: at block 1010 monitoring, with a cloud storage service, a data reduction parameter of cloud-based storage equipment; at block 1015 generating a data reduction metric based on the monitoring of the data reduction parameter; at block 1020 comparing the data reduction parameter metric to a defined normal data reduction criterion, at block 1025 determining that the data reduction metric does not satisfy the defined normal data reduction criterion; and at block 1030 responsive to the determining that the data reduction metric does not satisfy the defined normal data reduction criterion, facilitating a corrective action being performed in order to modify the data reduction metric to satisfy the defined normal data reduction criterion.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
monitoring, using a cloud storage service executing via cloud storage equipment comprising a processor, a characteristic parameter of a cloud-based computing resource;
generating a characteristic parameter metric based on the monitoring of the characteristic parameter;
comparing the characteristic parameter metric to a defined normal characteristic criterion; and
responsive to determining that the characteristic parameter metric does not satisfy the defined normal characteristic criterion, causing a corrective action to be performed.

2. The method of claim 1, wherein the cloud-based computing resource comprises storage to store one or more storage units and to share and synchronize the one or more storage units between remote computing devices that are communicatively coupled with the cloud-based computing resource.

3. The method of claim 2, wherein the corrective action comprises blocking access, by the cloud storage service, to the cloud-based computing resource of one of the remote computing devices that provided a most recent update of a storage unit associated with the characteristic parameter metric that does not satisfy the defined normal characteristic criterion.

4. The method of claim 1, wherein the corrective action comprises reverting a storage unit associated with the characteristic parameter metric that does not satisfy the defined normal characteristic criterion to a previous version of the storage unit and synchronizing the previous version to remote computing devices that are communicatively coupled with the cloud-based computing resource.

5. The method of claim 1, wherein the characteristic parameter monitored by the cloud service comprises a data reduction parameter applicable to data reduction.

6. The method of claim 5, wherein the characteristic parameter metric comprises a percentage data reduction corresponding to a storage unit with respect to which at least some of the data reduction was performed.

7. The method of claim 1, wherein the storage unit comprises a file.

8. A system, comprising:
a processor of a cloud storage computing system configured to execute a cloud storage service, the processor configured to:
generate a characteristic parameter metric based on monitoring a characteristic parameter of a cloud-based computing resource;
based on an evaluation of the characteristic parameter metric based on a normal characteristic criterion, determine that the characteristic parameter metric does not satisfy the normal characteristic criterion; and
responsive to the characteristic parameter metric being determined not to satisfy the normal characteristic criterion, initiating a corrective action.

9. The system of claim 8, wherein the cloud-based computing resource comprises storage to store one or more storage units, and to synchronize the one or more storage units between remote computing devices that are communicatively coupled with the cloud-based computing resource.

10. The system of claim 9, wherein the corrective action comprises blocking access to the cloud-based computing resource of one of the remote computing devices that provided a most recent update of a storage unit, of the one or more storage units and associated with the characteristic parameter metric, that does not satisfy the normal characteristic criterion.

11. The system of claim 8, wherein the corrective action comprises reverting a storage unit associated with the characteristic parameter metric that does not satisfy the normal characteristic criterion to a previous version of the storage unit and synchronizing the previous version to remote computing devices that are communicatively coupled with the cloud-based computing resource.

12. The system of claim 8, wherein the characteristic parameter monitored by the cloud service comprises a parameter relating to data reduction.

13. The system of claim 12, wherein the characteristic parameter metric comprises a percentage data reduction corresponding to a storage unit on which at least some of the data reduction was performed.

14. A non-transitory machine-readable medium, comprising executable instructions that, when executed by a processor, facilitate performance of operations, comprising:
monitoring, with a cloud storage service, a data reduction parameter of cloud-based storage equipment;
generating a data reduction metric based on the monitoring of the data reduction parameter;
comparing the data reduction parameter metric to a defined normal data reduction criterion,
determining that the data reduction metric does not satisfy the defined normal data reduction criterion; and
responsive to the determining that the data reduction metric does not satisfy the defined normal data reduction criterion, facilitating a corrective action being performed in order to modify the data reduction metric to satisfy the defined normal data reduction criterion.

15. The non-transitory machine-readable medium of claim 14, wherein the cloud-based storage is configured to store, share, and synchronize one or more files between remote computing devices that are communicatively coupled with the cloud-based storage equipment.

16. The non-transitory machine-readable medium of claim 15, wherein the corrective action comprises blocking access by the cloud storage service to the cloud-based storage of one of the remote computing devices that provided a most recent update of a file associated with the characteristic parameter metric that does not satisfy the defined normal characteristic criterion.

17. The non-transitory machine-readable medium of claim 14, wherein the facilitating of the corrective action comprises reverting a file associated with the characteristic parameter metric that does not satisfy the defined normal characteristic criterion to a previous version of the file and synchronizing the previous version to remote computing devices that are communicatively coupled with the cloud-based storage equipment.

18. The non-transitory machine-readable medium of claim 14, wherein the data reduction metric comprises a percentage of data reduction corresponding to a file with respect to which a data reduction operation was performed.

19. The non-transitory machine-readable medium of claim 14, wherein the data reduction metric comprises a percentage of data reduction corresponding to a folder with respect to which a data reduction operation was performed.

20. The non-transitory machine-readable medium of claim 14, wherein the defined normal data reduction criterion is based on one or more data reduction operations performed with respect to a folder based on the folder and contents of the folder being determined not to have been encrypted by a ransomware attack.
